(19) United States
(12) Patent Application Publication
(10) Pub. No.: US 2013/0042833 A1
(43) Pub. Date: Feb. 21, 2013

(54) Starting system, method and computer program product for starting an internal combustion engine

(71) Applicant: Sven HARTMANN, Stuttgart (DE)

(72) Inventor: Sven HARTMANN, Stuttgart (DE)

(21) Appl. No.: 13/586,625

(22) Filed: Aug. 15, 2012

(30) Foreign Application Priority Data
Aug. 17, 2011 (DE) 10 2011 081 093.5

(51) Int. Cl. F02N 11/00

(52) U.S. Cl. 123/179.25

(57) ABSTRACT

A starting system for an internal combustion engine, especially of a motor vehicle, equipped with a starting device and a starter control is described; the starting device includes an electrical machine, especially a starter motor, and the electrical machine is able to be actuated via an electrical machine switching device, the electrical machine being in operative connection with a crankshaft of the internal combustion engine via a mechanical device at least for starting the internal combustion engine. To avoid malfunctions in the starting system and in the method sequence in more optimal manner, especially during intensive use due to a start-stop operation, a safety device is provided, which may be used to check the actuating function of the starter motor.

### RELATED APPLICATION INFORMATION

The present application claims priority to and the benefit of German patent application no. 10 2011 081 093.5, which was filed in Germany on Aug. 17, 2011, the disclosure of which is incorporated herein by reference.

### FIELD OF THE INVENTION

The present invention relates to a starting system for an internal combustion engine, especially of a motor vehicle, equipped with a starting device and a starter control; the starting device includes an electrical machine, especially a starter motor, and the electrical machine is actuable via an electrical machine switching device, the electrical machine being in operative connection with a crankshaft of the internal combustion engine via a mechanical device, at least for starting the internal combustion engine, or it is able to be brought into such an operative connection. In addition, the present method relates to a method of a starting system, especially a starting system as described above, having a starting device and a starter control for starting an internal combustion engine, especially in a motor vehicle, the starting device including an electrical machine, especially a starter motor, and a machine switching device for applying a voltage to the electrical machine, which is actuated by the starter control, especially also in a start-stop operation, in order to apply a voltage to the starter motor for starting the internal combustion engine. The present invention also relates to a computer program product.

### BACKGROUND INFORMATION

To start an internal combustion engine, a direct-current motor having a starter pinion is normally used as starter motor, which, by an engagement relay, engages with a ring gear of the internal combustion engine, e.g., according to a pre-engaged drive principle, and then drives the internal combustion engine. At the end of the startup process, the starter pinion disengages from the ring gear again. The current developments provide for greater use of starting systems for a start-stop operation in motor vehicles. Greater demands are therefore placed on the starting system. For example, the increased demands are a higher number of cycles, greater acoustic requirements, and increased availability of the internal combustion engine in response to a power take-off wish. This gave rise to developments, such as those known from the following related art, according to which an engagement with a ring gear is to take place already while the internal combustion engine is in run-down mode, in order to increase the availability.

Another alternative for increasing availability, for example, are belt-driven starting systems, in particular belt starting systems or starters featuring permanent engagement, i.e., featuring a permanent operative connection of the starter motor with the ring gear of the crankshaft of the internal combustion engine.

Already known are belt-driven systems having a so-called starter generator for starting an internal combustion engine, which thus feature a permanent mechanical operative connection with the crankshaft of the internal combustion engine.

In addition, starting systems featuring a permanent engagement are known from motorcycles.

The German patent DE 197 21 386 A1 discusses a starting device for starting an internal combustion engine of a motor vehicle equipped with a starter relay, a starter motor and a control unit, the control unit including a current detection element for detecting current and voltage signals from the starter motor and the starter relay, and two semiconductors for the separate control of the electrical actuators. Using the current detection element, the starter relay can be controlled between three different stages and, in a start-stop operating mode, the starter motor can be actuated separately and run up slowly in controlled fashion.

### SUMMARY OF THE INVENTION

It is an object of the exemplary embodiments and/or exemplary methods of the present invention to further develop a starting system as well as a method and a computer program product of the type mentioned in the introduction, such that malfunctions in the starting system and the method are able to be avoided in more optimal manner, especially during more intensive use due to a start-stop operation.

According to the exemplary embodiments and/or exemplary methods of the present invention, the objective is attained by the subject matter described herein. The further descriptions specify refinements of the present invention.

One aspect of the exemplary embodiments and/or exemplary methods of the present invention is to provide a safety device, which may be used to check the actuation function of the electrical machine. It is therefore possible to determine whether the machine switching device is operating properly or whether a fault case is at hand, which should be avoided. To be avoided, in particular, is the fault case in which the machine switching device applies a voltage to the electrical machine, despite the fact that the internal combustion engine is at standstill or should be at standstill. In the negative case, this may cause the vehicle to move, contrary to intentions. This may occur in particular when the starter or the starting system, especially a belt starting system, is in permanent engagement. The fault case may arise if, for example, contact welds are produced on the machine switching device, especially on the starter relay, and the starter relay no longer opens correctly, so that the starter motor remains energized. This case may also arise in electronic high-current actuations, e.g., in the starter generator. Especially this fault case must be prevented.

According to one further specific development, the safety device assumes the actuating function in the event of a fault. In other words, if it is detected that the machine switching device, especially the starter relay, no longer opens an electrical switching contact, but keeps it permanently closed instead, the current interruption for the voltage application of the starter motor is carried out by the safety device. The safety device thus constitutes a redundant system for fault cases of the starter relay.

According to one development of the exemplary embodiments and/or exemplary methods of the present invention, the safety device includes a switching device connected in series with the machine switching device, which is controlled by a safety control. Thus, the switching device produces a redundant switch, which in the event of a fault assumes the actuation of the electrical machine via the safety control, at least operating also as starter motor, if the machine switching device always switches through and thus no longer interrupts the contact.

According to one specific embodiment which further develops the present invention, the switching device is developed as contact closer, especially as relay. This has the advantage that the switching device is a redundant switch which is energized only in order to activate the electrical machine in the function of a starter motor. As an alternative, the switching device is a contact opener, which needs to be opened only in the event of a fault. In a further manner, the switching device is actuable with the aid of a so-called flip-flop switch, so that electrical energy is required only if a fault arises, in order to open the switching contact. In addition, the switching device may nevertheless be used as contact closer, if it is meant to assume the operation of the machine switching device or the starter relay in the event of a fault. A relay has the advantage of allowing high switching currents and voltages to be switched by small control currents. Since a starter motor or an electrical machine is able to have up to approximately 1000 Ampere applied, relays that are switched using approximately 2 to approximately 20 Ampere, for example, may be used.

In a further manner, the safety device includes a monitoring device and an evaluation device, which monitors and analyzes actuating signals and/or crankshaft speeds of the internal combustion engine, and/or electrical quantities, especially the voltage and/or the electrical current at the starter motor. The actuating signals are the control signals output to the starter control, which are compared to the electrical quantities at the starter motor. If they indicate implausible results, a defective starter relay may be assumed, so that the safety device having the safety control becomes active. The same applies to the crankshaft speed of the internal combustion engine, if, for example, it has an excessive or implausible rotational speed, for instance because the internal combustion engine has already been switched off by the engine control of the internal combustion engine.

To improve the availability in start-stop operation using the simplest constructive approach possible, and in order to achieve a high service life, the starting device may be configured so that the starter pinion and the ring gear of the internal combustion engine are in permanent engagement, or also in belt operation. The ring gear may be connected to the internal combustion engine in a free-running assembly, so that it is possible for the ring gear to rotate more slowly in relation to the internal combustion engine or to be stationary, whereas the internal combustion engine has a higher or a high rotational speed at the crankshaft.

This has the advantage that no acoustic noises of an engagement device are able to occur in start-stop operation, and furthermore, a startup is possible at any time, even if the internal combustion engine is already running down, that is to say, has not yet achieved a low rotational speed or a rotational speed of zero, at which an engagement is first possible. However, this permanent engagement has the disadvantage that fault cases of the starter relay are more serious than in conventional systems, in which the starter pinion disengages following the startup process. In these conventional systems it is then ultimately unimportant whether a voltage is still applied at the starter motor, since the starter pinion is already disengaged. As a result, the conventional systems are already secured in redundant fashion by way of the disengagement. This function is omitted due to a permanent engagement.

In order to improve the safety demands even further, in one further specific embodiment an additional series relay, which is actuable by the starter control having the safety device, is connected upstream from the switching device and, in particular, the starter relay. This has the advantage that, once again via the starter control, the switching device and the machine switching device, the starter relay, are able to be triggered using small control currents.

The objective is also achieved by a method, in that the function of the machine switching device, in particular the starter relay, is monitored by a safety device, and the effect of the machine switching device, such as the starter relay, is deactivated by the safety device in the event of a fault. In cases where the machine switching device still switches through, for instance because of a contact weld, it is therefore prevented that the vehicle remains drivable, even if the machine switching device, i.e., the starter relay, is defective. This avoids a vehicle that moves in uncontrolled manner.

According to one further specific embodiment, in the event of a fault of the machine switching device, the electrical machine, especially the starter motor, is redundantly actuated by the safety device via the switching device as part of the safety device. The switching device of the safety device therefore assumes the complete function of the machine switching device, in particular the starter relay, due to the simple fault, if the relay contact of the starter relay no longer opens and the starting current is therefore no longer switched off. In such a case, a corresponding message device may be used to inform the driver, either visually and/or additionally acoustically, that a fault is at hand which must be remedied as quickly as possible in a service facility. That is to say, an “emergency operation with service facility warning” takes place.

The objective is also achieved by a computer program product, which is loadable into a program memory including program instructions of a microcomputer, in order to execute all of the steps of a previously described method or a method to be described in the following text, in particular when the computer program product is executed in an afore-described starting system. The microcomputer may be part of the device, and the control, especially if a plurality of devices is provided in a system, may also include multiple microcomputers and also memories, as well as a plurality of computer program products or also a realized computer program product that is distributed to the multiplicity of devices. The computer program product requires only a few or no additional components in the control, and may be implementable as module in an already existing control. The computer program product is storable on a physical medium such as a memory chip, and has the additional advantage that it is easily adaptable to individual and particular customer demands and to empirically determined values, and that individual method steps are able to be improved or optimized with little effort in a cost-effective manner.

It is understood that the aforementioned features, which will be discussed below, are able to be used not only in the individually indicated combination, but in other combinations as well.

The exemplary embodiments and/or exemplary methods of the present invention are elucidated in greater detail below, with reference to the drawing.

### BRIEF DESCRIPTION OF THE DRAWINGS

FIG. 1 shows a schematic plan of a starting system featuring a permanent engagement.

FIG. 2 shows a schematic plan view of a starting system according to a second specific embodiment.

FIG. 3 shows a flow chart of a method according to the present invention.

### DETAILED DESCRIPTION

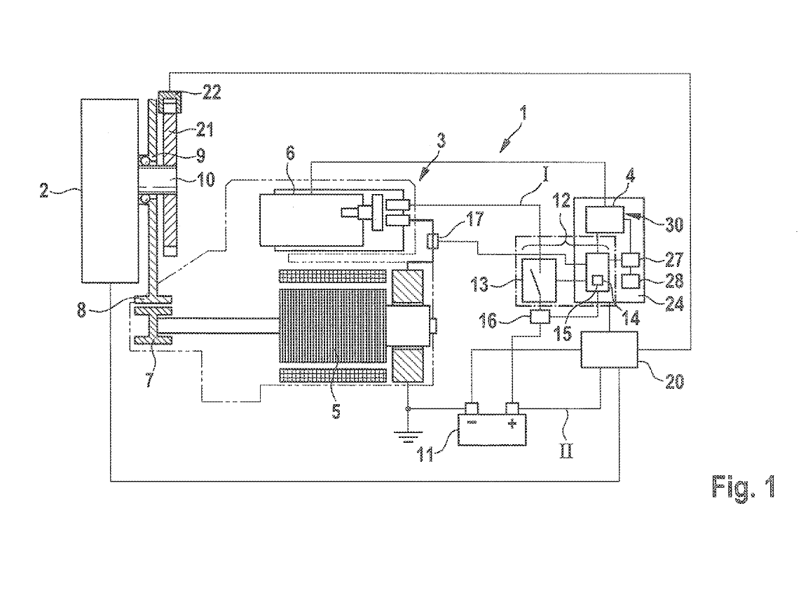

FIG. 1 shows a schematic plan of a starting system 1 for starting an internal combustion engine 2 with the aid of a starting device 3 and a starter control 4. Starting device 3 includes an electrical machine, in the form of a starter motor 5, and a machine switching device, in the form of a starter relay 6. Starter motor 5 drives a starter pinion 7 on a driven shaft, which starter pinion is in permanent engagement with a ring gear 8 for starting internal combustion engine 2. Ring gear 8 includes an overrunning clutch 9, via which ring gear 8 is able to be slower, or even stand still, in relation to crankshaft 10 of internal combustion engine 2. As a result, a torque is transmittable to crankshaft 10 solely in the driving direction.

Because of starter pinion 7 which is in permanent engagement with ring gear 8, it is possible to start internal combustion engine 2 at any time during start-stop operation, even if crankshaft 10 is not yet at standstill or does not have sufficiently low speeds as yet, which translates into greater availability in comparison with conventional starting systems 1 having a pinion-engaging system that engages starter pinion 7 with ring gear 8.

Conventionally, a starting device 3 provided with a pinion-engaging device that engages starter pinion 7 with ring gear 8 in order to start internal combustion engine 2 has a safety stage in order to prevent fault cases. In the event that starter relay 6 still energizes starter motor 5 because of a contact weld, starter pinion 7 is disengaged following the startup of internal combustion engine 2, and the starter pinion rotates idly and thus does not drive crankshaft 10.

This safety function is no longer provided in a starter pinion 7 that is in permanent engagement. Therefore, it is an aspect of the exemplary embodiments and/or exemplary methods of the present invention to provide this redundancy, as an alternative, by a safety device 12 according to the present invention. Safety device 12 includes, for one, a switching device 13, which may be connected in series with starter relay 6, which may be upstream from starter relay 6 in the current path of starter motor 5. As a result, switching device 13 is switched directly at battery 11 serving as electrical energy supply for the vehicle electrical system.

Separately from this switching circuit I, additional switching circuits II are provided as onboard electrical system in a vehicle, e.g., for an engine control 20 which actuates internal combustion engine 2 and is connected to starter control 4 and safety device 12 for the exchange of information.

Furthermore, safety device 12 includes a monitoring device 15, which, for one, has sensors 16, 17, 22 for measuring the voltage drop at starter motor 5, or which is also able to detect the current consumption and the engine speed of the internal combustion engine, which is transmittable via engine control 20, for example. In addition, startup requests are also transmitted to starter control 4 or to safety control 14 by way of engine control 20 or some other higher-level control, using a signal line 30. The crankshaft speed is determined with the aid of a known and already conventionally provided tooth gap wheel 21 on crankshaft 10, using a sensor 22.

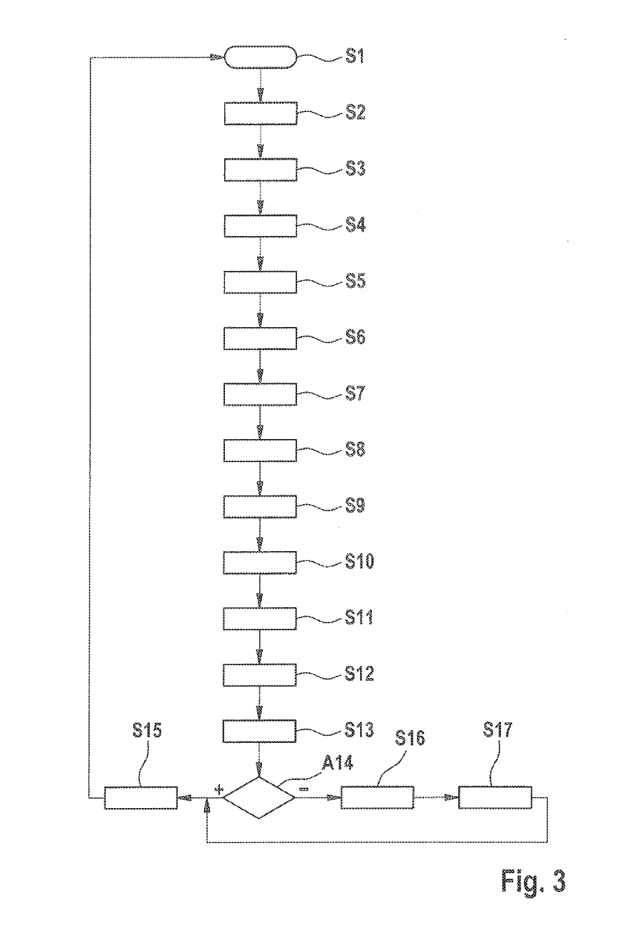

Safety control 14, for one, actuates switching device 13 and, for another, safety control 14 checks starter relay 6, in which monitored values such as the voltage at starter motor 5, the current consumption or rotational speed n of internal combustion engine 2 are utilized to carry out a plausibility check of these or individual monitored values in connection with a startup request. On this basis it is then evaluated whether a fault at starter relay 6 is present. The precise method sequence is described in FIG. 3.

Due to the use of safety device 12 according to the present invention in a starting system 1 having a starter pinion 7 in permanent engagement, it is possible to operate a vehicle in reliable manner. If starter relay 6 is no longer operating properly, i.e., no longer opens because of a contact weld, for example, it is furthermore possible that safety device 12 having switching device 13 assumes the task of starter relay 6.

Since switching device 13 is closed initially, no welds or sparks develop at the contact of switching device 13. Contact welds are thus avoided.

At the same time, monitoring device 15 is also used for checking the functioning of switching device 13, e.g., by switching machine switching device 6 with open safety switch 13 at sensor 17 to apply a voltage. In a starting device without engagement function, this check is able to be executed by starter relay 6 following the startup operation. In a starting device featuring an engagement function during standstill, starter relay 6 closes by a brief actuation, switching device 13 not being actuated, which means that no voltage should be present at the sensor either; if this is not the case, a malfunction of switching device 13 would otherwise be detected.

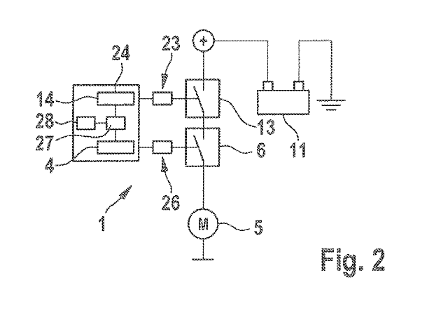

FIG. 2 shows another special specific embodiment as circuit diagram of starting system 1 according to the present invention. In this starting system 1, starter control 4 and safety control 14 are shown and unified as a structural unit in the form of a starting system control 24. The configuration is therefore simplified because, for example, a shared microprocessor 27 having a shared memory 28 is used as a rule in an engine control device. Series relays 23 and 26 are provided in order to switch high currents by starting system control 24, which are required for switching starter relay 6 and switching device 13, for example. Series relays 23 and 26 thus allow the switching of control currents up to 20 Ampere using low control currents, such as up to 2 Ampere. Series relays 23, 26 therefore act as amplifiers.

FIG. 3 shows a flow chart of a method sequence according to the present invention, as it is executed in starting system 1 according to the exemplary embodiments and/or exemplary methods of the present invention.

In a first step S1, a startup request is output to starting system 1, in this case, to starter control 4 or starting system control 24 for starting internal combustion engine 2. Starting system 1 is waiting for this start request in step S1. Starting system control 24 or starter control 4 is in contact with safety control 14 for the exchange of information.

According to one specific embodiment, safety control 12 thus initially actuates switching device 13 of safety device 12 in a step S2. As a result, switching circuit I is closed, with the exception of switch relay 6.

In a next step S3, starter control 4 actuates starter relay 6.

Starter motor 5 begins to rotate in step S4. A maximum current of up to approximately 1000 Ampere is applied to starter motor 5.

Using starter pinion 7, starter motor 5 drives ring gear 8 and starts internal combustion engine 2 in step S5. Via sensors 16, 17, 22, engine control 20 checks whether internal combustion engine 2 has started up. These sensors are either an rpm sensor 22, which exchanges information with engine control 20, or a current and/or a voltage sensor 16, 17 in the current path of starter motor 5, which exchange information with engine control 20.

If engine control 20 detects a started-up internal combustion engine 2, in a step S6 it outputs the control signal to starter control 4 that starter relay 6 is to interrupt current circuit I again in following step S7.

In step S8, starter motor 5 then stops, provided starter relay 6 is functioning properly and, for example, no contact weld is present. If a contact weld is present, current circuit I would continue to be closed.

The proper method of functioning of starter motor 6 is checked in the following steps; according to the exemplary embodiments and/or exemplary methods of the present invention, the method of functioning is additionally checked with the aid of starting system control 24 in the development as a safety device 12.

Safety device 12 may execute a plausibility check of three individual sensor signals, in parallel or one after the other, in connection with a startup request.

In a step S9, the voltage at starter motor 5 may be measured via a voltage sensor 17 and subjected to a plausibility check with the startup request, which also includes a stop request, at input signal 30 of starter control 4.

In a step S10, the current at starter motor 5 is measured and likewise checked with the startup request via the input signal in path 30. If the voltage and the current are unusually high although no startup request is present as step S12 at signal line 30, then safety device 12, in an evaluation step S13, may assume that starter relay 6 is no longer operating correctly.

Furthermore, rotational speed n of crankshaft 10 may be queried by internal combustion engine 2 via an rpm sensor 22 in a check step S11, and subjected to a plausibility check. For example, if no startup request is present in step S12 and if internal combustion engine 2 should actually be switched off but crankshaft 10 is rotating nevertheless, it may be assumed that a voltage is applied at starter motor 5, which is undesired and evaluated as fault case. This is checked in evaluation step S13.

Evaluation step S13 is followed by a query step A14, in which a query takes place as to whether starter relay 6 is working properly. If the answer is positive, switching device 13 is opened in step S15 and the control transitions to step S1 again, in which a wait takes place until engine control 20 outputs a startup request to starter control 4 via signal line 30, e.g., because of a start-stop operation.

If it is detected in query step A14 that starter relay 6 is operating incorrectly and, for example, switches current path I through although it should be opened, then, in step S15, a corresponding display device informs the driver acoustically and/or visually that starter relay 6 in starting system 1 or some component is not operating correctly, so that technical servicing must take place as soon as possible.

In addition, the control of starting system 1 transitions to a step S17, in which safety control 14 additionally assumes the task of starting device 3. Switching device 13 is therefore used as redundant switch to starter relay 6, so that, for a startup request, it now matters whether switching device 13 closes or reopens current circuit I of starter motor 5. Afterward, starting system control 24 returns to step S15 again, according to which switching device 13 safely opens current circuit I of starter motor 5.

Using the method according to the present invention and by executing a stored computer program product in the form of a readable medium, a second redundancy is thus provided for a starting system 1 according to the present invention, in particular for starting systems 1 having a starter pinion 7 in permanent engagement with ring gear 8 of internal combustion engine 2. Potential malfunctions of starter motor 5 are therefore avoided.

It is understood that starting system control 24 may include both the starter control 4 and safety control 14 as well as shared components such as microcomputer 27 having a program memory 18, in order to reduce the number of components and to simplify them. All the figures show only schematic illustrations which are not to scale. In all other respects, reference is made especially to the figures in connection with the exemplary embodiments and/or exemplary methods of the present invention.

What is claimed is:

1. A starting system for an internal combustion engine of a motor vehicle, comprising:
a starting device and a starter control, the starting device including an electrical machine, which includes a starter motor, the electrical machine being actuable via an electrical machine switching device, and the electrical machine being in operative connection with a crankshaft of the internal combustion engine via a mechanical device at least for starting the internal combustion engine; and
a safety device, with the aid of which the actuating function of the electrical machine is able to be checked.

2. The starting system of claim 1, wherein in the event of a fault, the safety device is able to assume the actuating function, and wherein the safety device has a separate onboard electrical system.

3. The starting system of claim 1, wherein the safety device has a switching device connected in series with the machine switching device, which is actuated by a safety control.

4. The starting system of claim 1, wherein the switching device is configured as a contact closer, which includes a relay.

5. The starting system of claim 1, wherein the safety device includes a monitoring device and an evaluation device, which at least one of (i) monitors and analyzes at least one of actuating signals and a crankshaft speed of the internal combustion engine, and (ii) monitors and evaluates electrical quantities, including at least one of a voltage and an electrical current at the electrical machine.

6. The starting system of claim 1, wherein the starting device is configured so that a starter pinion is able to be brought into engagement with a ring gear of the internal combustion engine.

7. The starting system of claim 1, wherein a series relay, which is actuable by the starter control having the safety device, is connected upstream from the switching device and the starter relay.

8. A method for use with a starting system for starting an internal combustion engine of a vehicle, the method comprising:
applying a voltage, in the starting system, which includes a starting device and a starter control, the starting device including an electrical machine, which includes a starter motor, and a machine switching device, by using the machine switching device, to the electrical machine, which is actuated by the starter control, including in a start-stop operation, for starting the internal combustion engine;
monitoring the function of the machine switching device with a safety device; and
deactivating the effect of the machine switching device using the safety device in the event of a fault.

9. The method of claim 8, wherein in the event of a fault of the machine switching device, the safety device actuates the electrical machine in redundant fashion via a switching device as part of the safety device.

10. A computer readable medium having a computer program, which is executable by a processor, comprising:
a program code arrangement having program code for starting an internal combustion engine of a vehicle, by performing the following:
applying a voltage, in the starting system, which includes a starting device and a starter control, the starting device including an electrical machine, which includes a starter motor, and a machine switching device, by using the machine switching device, to the electrical machine, which is actuated by the starter control, including in a start-stop operation, for starting the internal combustion engine;
monitoring the function of the machine switching device with a safety device; and
deactivating the effect of the machine switching device using the safety device in the event of a fault.
